(19) United States
(12) Patent Application Publication
(10) Pub. No.: US 2014/0283578 A1
(43) Pub. Date: Sep. 25, 2014

(54) MOBILE DEVICE AND VEHICLE MOUNTED SENSOR CALIBRATION

(71) Applicant: QUALCOMM Incorporated, San Diego, CA (US)

(72) Inventors: Joseph Czompo, San Jose, CA (US); Benjamin A. Werner, Santa Clara, CA (US); William James Morrison, San Francisco, CA (US)

(73) Assignee: QUALCOMM Incorporated, San Diego, CA (US)

(21) Appl. No.: 14/087,596

(22) Filed: Nov. 22, 2013

Related U.S. Application Data
(60) Provisional application No. 61/804,460, filed on Mar. 22, 2013.

(51) Int. Cl. G01C 25/00

(52) U.S. Cl. CPC G01C 25/005
USPC 73/1.37; 73/504.02

(57) ABSTRACT

The disclosure generally relates to calculating gyroscope bias in a vehicle. Methods, apparatus and systems are disclosed. A method can include: assuming a maximum turning rate for a vehicle based at least in part on speed of the vehicle; and determining gyroscope bias information based at least in part on the assumed maximum turning rate.

### CROSS-REFERENCE TO RELATED APPLICATION

The present Application for Patent claims the benefit of U.S. Provisional Application No. 61/804,460, entitled “MOBILE DEVICE AND VEHICLE MOUNTED SENSOR CALIBRATION,” filed Mar. 22, 2013, assigned to the assignee hereof, and expressly incorporated herein by reference in its entirety.

### FIELD OF DISCLOSURE

Disclosed embodiments relate to calculating the bias of a gyroscope sensor. More particularly, exemplary embodiments are directed to calibrating mobile devices and vehicle sensors.

### BACKGROUND

Mobile communications networks are in the process of offering increasingly sophisticated capabilities associated with the motion and/or position location sensing of a mobile device. New software applications, such as, for example, those related to personal productivity, collaborative communications, social networking, and/or data acquisition, may utilize motion and/or position sensors to provide new features and services to consumers. Moreover, some regulatory requirements of various jurisdictions may require a network operator to report the location of a mobile device when the mobile device places a call to an emergency service, such as a 911 call in the United States.

Such motion and/or position determination capabilities have conventionally been provided using digital cellular positioning techniques and/or Satellite Positioning Systems (SPS). Additionally, with the increasing proliferation of miniaturized motion sensors (e.g., simple switches, accelerometers, angle sensors, etc), such on-board devices may be used to provide relative position, velocity, acceleration, and/or orientation information.

In conventional digital cellular networks, position location capability can be provided by various time and/or phase measurement techniques. For example, in CDMA networks, one position determination approach used is Advanced Forward Link Trilateration (AFLT). Using AFLT, a mobile device may compute its position from phase measurements of pilot signals transmitted from a plurality of base stations. Improvements to AFLT have been realized by utilizing hybrid position location techniques, where the mobile station may employ an SPS receiver that can provide position information independent of the information derived from the signals transmitted by the base stations. Moreover, position accuracy can be improved by combining measurements derived from both SPS and AFLT systems using conventional techniques.

In conventional digital cellular networks, position location capability can be provided by various time and/or phase measurement techniques. For example, in CDMA networks, one position determination approach used is Advanced Forward Link Trilateration (AFLT). Using AFLT, a mobile device may compute its position from phase measurements of pilot signals transmitted from a plurality of base stations. Improvements to AFLT have been realized by utilizing hybrid position location techniques, where the mobile station may employ an SPS receiver that can provide position information independent of the information derived from the signals transmitted by the base stations. Moreover, position accuracy can be improved by combining measurements derived from both SPS and AFLT systems using conventional techniques.

Furthermore, navigation devices often support popular and increasingly important SPS wireless technologies which may include, for example, the Global Positioning System (GPS) and/or a Global Navigation Satellite System (GNSS). Navigation devices supporting SPS may obtain navigation signals as wireless transmissions received from one or more transmitter equipped satellites that may be used to estimate geographic position and heading. Some navigation devices may additionally or alternatively obtain navigation signals as wireless transmissions received from terrestrial based transmitters to estimate geographic position and heading and/or include one or more inertial sensors (e.g., accelerometers, gyroscopes, etc.) that reside on-board the navigation device to measure an inertial state of the navigation device. Inertial measurements obtained from these inertial sensors may be used in combination with or independent of navigation signals received from satellite and/or terrestrial based transmitters to provide estimates of geographic position and heading.

In a navigation system, sensors such as gyroscopes and odometry can provide a dead reckoning capability. Dead reckoning can improve positioning performance by allowing accurate positioning propagation and the rejection of data with unmodeled errors. However, the ability to dead reckon can depend on how well sensor errors can be removed from raw sensor data. A vehicle-mounted gyroscope can have its bias calculated over time for dead reckoning. Similarly, a device can have its gyroscopes calibrated.

### SUMMARY

Exemplary embodiments of the invention are directed to systems and method for calculating gyroscope bias in a vehicle.

For example, an exemplary embodiment is directed to a method for calculating gyroscope bias in a vehicle, the method comprising: assuming a maximum turning rate for a vehicle based at least in part on speed of the vehicle; and determining gyroscope bias information based at least in part on the assumed maximum turning rate.

Another exemplary embodiment is directed to an apparatus for calculating gyroscope bias in a vehicle, the apparatus comprising: means for assuming a maximum turning rate for a vehicle based at least in part on speed of the vehicle; and means for determining gyroscope bias information based at least in part on the assumed maximum turning rate.

Yet another exemplary embodiment is directed to an apparatus for calculating gyroscope bias in a vehicle, the apparatus comprising: a turning rate circuit configured to assume a maximum turning rate for a vehicle based at least in part on speed of the vehicle; and a gyroscope bias circuit configured to determine gyroscope bias information based at least in part on the assumed maximum turning rate.

Still another exemplary embodiment is directed to a non-transitory computer-readable storage medium comprising code, which, when executed by a processor, causes the processor to perform operations for calculating gyroscope bias in a vehicle, the non-transitory computer-readable storage medium comprising: code for assuming a maximum turning rate for a vehicle based at least in part on speed of the vehicle; and code for determining gyroscope bias information based at least in part on the assumed maximum turning rate.

Advantages of the present invention may include improvement in dead reckoning using data available from sensor calibration of both vehicle onboard sensors and a mobile device's sensors.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary operating environment for a mobile station that can determine position using wireless techniques, according to one aspect of the disclosure.

FIG. 2 illustrates an exemplary mobile station that may be used in an operating environment that can determine position using wireless techniques, according to one aspect of the disclosure.

FIG. 3 shows a graph of exemplary angular rate limitations in a vehicle.

FIG. 4 illustrates an exemplary vehicle with paths for different turning degrees.

FIG. 5 illustrates an operational flow of a method for calculating gyroscope bias in a vehicle.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

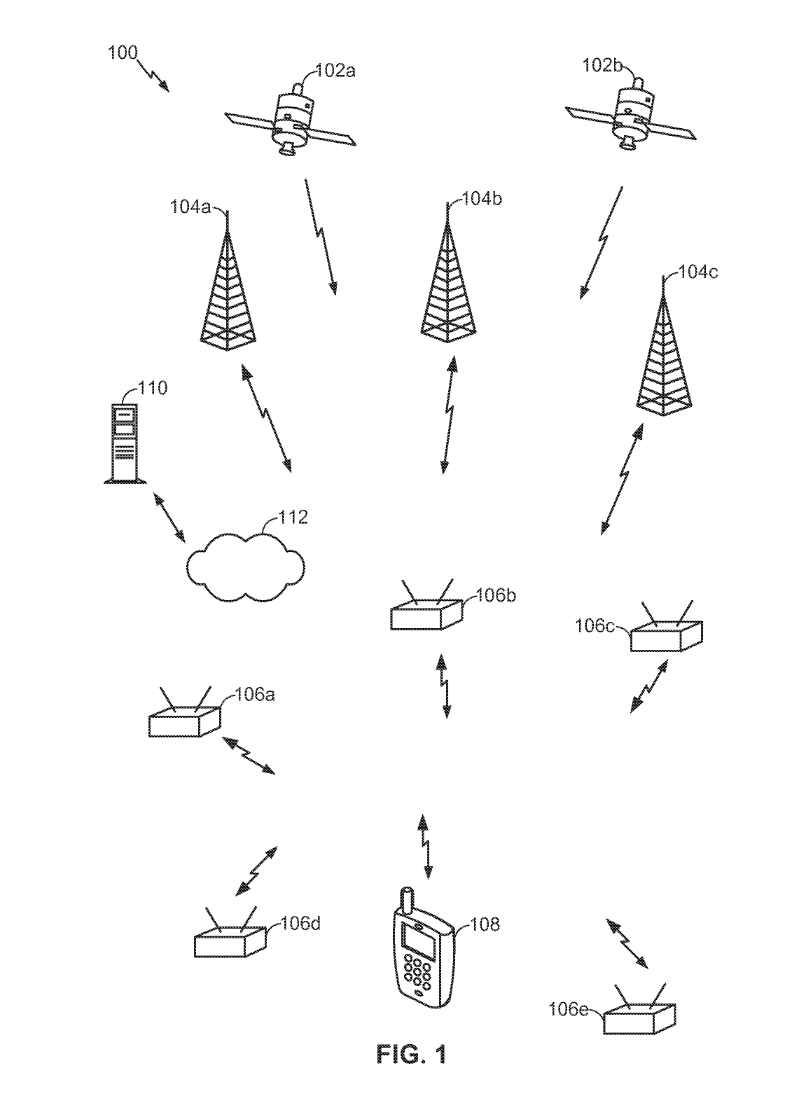

According to one aspect of the disclosure, FIG. 1 illustrates an exemplary operating environment 100 for a mobile station 108 having wireless positioning capability. Embodiments are directed to a mobile station 108 which may determine its position based upon round trip time (RTT) measurements that are adjusted to accommodate for processing delays introduced by wireless access points. The processing delays may vary among different access points and may also change over time. By using information from a motion sensor, the mobile station 108 may calibrate out the effects of the processing delays introduced by the wireless access points.

The operating environment 100 may contain one or more different types of wireless communication systems and/or wireless positioning systems. In the embodiment shown in FIG. 1, a Satellite Positioning System (SPS) 102 may be used as an independent source of position information for the mobile station 108. The mobile station 108 may include one or more dedicated SPS receivers specifically designed to receive signals for deriving geo-location information from the SPS satellites.

The operating environment 100 may also include one or more Wide Area Network Wireless Access Points (WAN-WAPs) 104, which may be used for wireless voice and/or data communication, and as another source of independent position information for the mobile station 108. The WAN-WAPs 104 may be part of a wide area wireless network (WWAN), which may include cellular base stations at known locations, and/or other wide area wireless systems, such as, for example, WiMAX (e.g., 802.16). The WWAN may include other known network components which are not shown in FIG. 1 for simplicity. Typically, each of the WAN-WAPs 104a-104c within the WWAN may operate from fixed positions, and provide network coverage over large metropolitan and/or regional areas.

The operating environment 100 may further include one or more Local Area Network

Wireless Access Points (LAN-WAPs) 106, which may be used for wireless voice and/or data communication, as well as another independent source of position data. The LAN-WAPs can be part of a Wireless Local Area Network (WLAN), which may operate in buildings and perform communications over smaller geographic regions than a WWAN. Such LAN-WAPs 106 may be part of, for example, WLAN networks (802.11x), cellular piconets and/or femtocells, Bluetooth Networks, etc.

The mobile station 108 may derive position information from any one or more of the SPS satellites 102, the WAN-WAPs 104, and/or the LAN-WAPs 106. Each of the aforementioned systems can provide an independent estimate of the position for the mobile station 108 using different techniques. In some embodiments, the mobile station 108 may combine the solutions derived from each of the different types of access points to improve the accuracy of the position data. When deriving position using the SPS 102, the mobile station 108 may utilize a receiver specifically designed for use with the SPS that extracts position, using conventional techniques, from a plurality of signals transmitted by SPS satellites 102.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground-based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

Furthermore, the disclosed method and apparatus may be used with positioning determination systems that utilize pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where GPS signals from an orbiting satellite might be unavailable, such as in tunnels, mines, buildings, urban canyons or other enclosed areas. Another implementation of pseudolites is known as radio-beacons. The term “satellite”, as used herein, is intended to include pseudolites, equivalents of pseudolites, and possibly others. The term “SPS signals,” as used herein, is intended to include SPS-like signals from pseudolites or equivalents of pseudolites.

When deriving position from the WWAN, each WAN-WAPs 104a-104c may take the form of base stations within a digital cellular network, and the mobile station 108 may include a cellular transceiver and processor that can exploit the base station signals to derive position. Such cellular networks may include, but are not limited to, standards in accordance with GSM, CMDA, 2G, 3G, 4G, LTE, etc. It should be understood that digital cellular network may include additional base stations or other resources that may not be shown in FIG. 1. While WAN-WAPs 104 may actually be movable or otherwise capable of being relocated, for illustration purposes it will be assumed that they are essentially arranged in a fixed position.

The mobile station 108 may perform position determination using known time-of-arrival (TOA) techniques such as, for example, Advanced Forward Link Trilateration (AFLT). In other embodiments, each WAN-WAP 104a-104c may comprise a Worldwide Interoperability for Microwave Access (WiMAX) wireless networking base station. In this case, the mobile station 108 may determine its position using TOA techniques from signals provided by the WAN-WAPs 104. The mobile station 108 may determine positions either in a stand-alone mode, or using the assistance of a positioning server 110 and network 112 using TOA techniques, as will be described in more detail below. Furthermore, various embodiments may have the mobile station 108 determine position information using WAN-WAPs 104, which may have different types. For example, some WAN-WAPs 104 may be cellular base stations, and other WAN-WAPs 104 may be WiMAX base stations. In such an operating environment, the mobile station 108 may be able to exploit the signals from each different type of WAN-WAP 104, and further combine the derived position solutions to improve accuracy.

When deriving position using the WLAN, the mobile station 108 may utilize time of arrival techniques with the assistance of the positioning server 110 and the network 112. The positioning server 110 may communicate to the mobile station 108 through network 112. Network 112 may include a combination of wired and wireless networks which incorporate the LAN-WAPs 106. In one embodiment, each LAN-WAP 106a-106e may be, for example, a WLAN wireless access point, which is not necessarily set in a fixed position and can change location. The position of each LAN-WAP 106a-106e may be stored in the positioning server 110 in a common coordinate system. In one embodiment, the position of the mobile station 108 may be determined by having the mobile station 108 receive signals from each LAN-WAP 106a-106e. Each signal may be associated with its originating LAN-WAP based upon some form of identifying information that may be included in the received signal (such as, for example, a MAC address). The mobile station 108 may then sort the received signals based upon signal strength, and derive the time delays associated with each of the sorted received signals. The mobile station 108 may then form a message which can include the time delays and the identifying information of each of the LAN-WAPs, and send the message via network 112 to the positioning sever 110. Based upon the received message, the positioning server may then determine a position, using the stored locations of the relevant LAN-WAPs 106, of the mobile station 108. The positioning server 110 may generate and provide a Location Configuration Indication (LCI) message to the mobile station 108 that includes a pointer to the position of the mobile station 108 in a local coordinate system. The LCI message may also include other points of interest in relation to the location of the mobile station 108. When computing the position of the mobile station 108, the positioning server may take into account the different delays which can be introduced by elements within the wireless network.

The position determination techniques described herein may be used for various wireless communication networks such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) and so on. A CDMA network may implement one or more radio access technologies (RATs) such as cdma2000, Wideband-CDMA (W-CDMA), and so on. cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

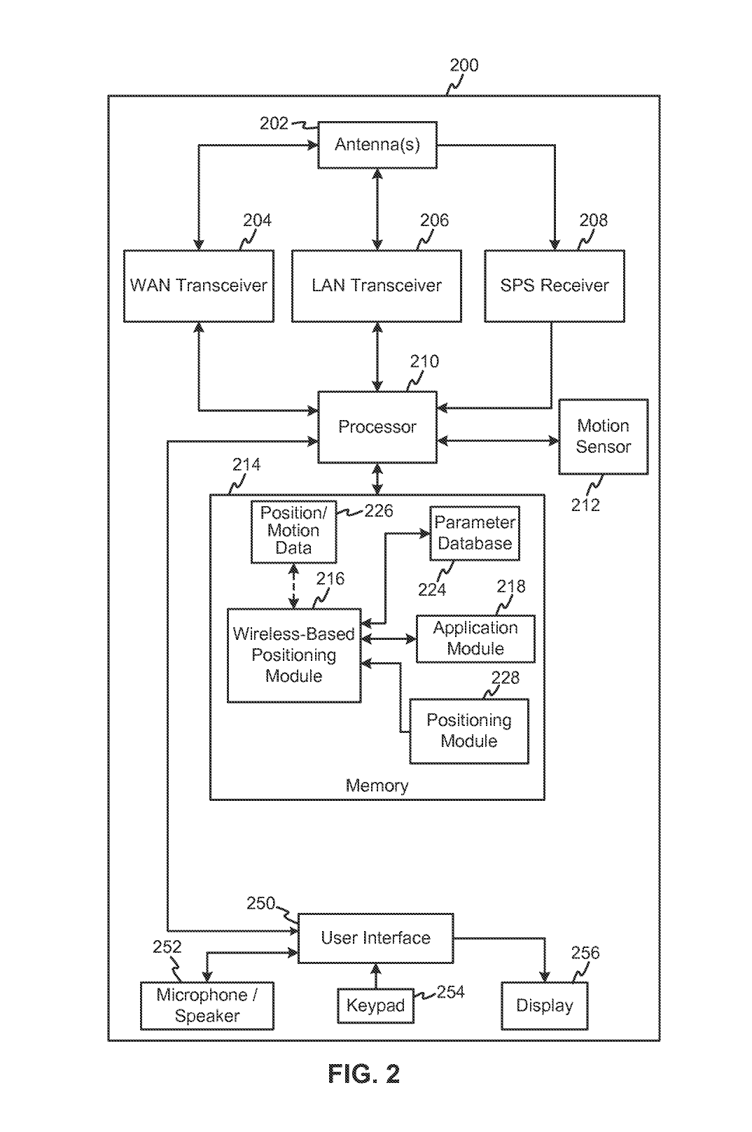

FIG. 2 is a block diagram illustrating various components of an exemplary mobile station 200. For the sake of simplicity, the various features and functions illustrated in the box diagram of FIG. 2 are connected together using a common bus which is meant to represent that these various features and functions are operatively coupled together. Those skilled in the art will recognize that other connections, mechanisms, features, functions, or the like, may be provided and adapted as necessary to operatively couple and configure an actual portable wireless device. Further, it is also recognized that one or more of the features or functions illustrated in the example of FIG. 2 may be further subdivided or two or more of the features or functions illustrated in FIG. 2 may be combined.

The mobile station 200 may include one or more wide area network (WAN) transceiver(s) 204 that may be connected to one or more antennas 202. The WAN transceiver 204 comprises suitable devices, hardware, and/or software for communicating with and/or detecting signals to/from WAN-WAPs 104, and/or directly with other wireless devices within a network. In one aspect, the WAN transceiver 204 may comprise a CDMA communication system suitable for communicating with a CDMA network of wireless base stations; however in other aspects, the wireless communication system may comprise another type of cellular telephony network, such as, for example, TDMA or GSM. Additionally, any other type of wide area wireless networking technologies may be used, for example, WiMAX (802.16), etc. The mobile station 200 may also include one or more local area network (LAN) transceivers 206 that may be connected to one or more antennas 202. The LAN transceiver 206 comprises suitable devices, hardware, and/or software for communicating with and/or detecting signals to/from LAN-WAPs 106, and/or directly with other wireless devices within a network. In one aspect, the LAN transceiver 206 may comprise a WLAN (802.11x) communication system suitable for communicating with one or more wireless access points; however in other aspects, the LAN transceiver 206 comprise another type of local area network, personal area network, (e.g., Bluetooth). Additionally, any other type of wireless networking technologies may be used, for example, Ultra Wide Band, ZigBee, wireless USB etc.

As used herein, the abbreviated term “wireless access point” (WAP) may be used to refer to LAN-WAPs 106 and/or WAN-WAPs 104. Specifically, in the description presented below, when the term “WAP” is used, it should be understood that embodiments may include a mobile station 200 that can exploit signals from a plurality of LAN-WAPs 106, a plurality of WAN-WAPs 104, or any combination of the two. The specific type of WAP being utilized by the mobile station 200 may depend upon the environment of operation. Moreover, the mobile station 200 may dynamically select between the various types of WAPs in order to arrive at an accurate position solution. In other embodiments, various network elements may operate in a peer-to-peer manner, whereby, for example, the mobile station 200 may be replaced with the WAP, or vice versa. Other peer-to-peer embodiments may include another mobile station (not shown) acting in place of one or more WAP.

An SPS receiver 208 may also be included in the mobile station 200. The SPS receiver 208 may be connected to the one or more antennas 202 for receiving satellite signals. The SPS receiver 208 may comprise any suitable hardware and/or software for receiving and processing SPS signals. The SPS receiver 208 requests information and operations as appropriate from the other systems, and performs the calculations necessary to determine the mobile station's 200 position using measurements obtained by any suitable SPS algorithm.

A motion sensor 212 may be coupled to a processor 210 to provide movement and/or orientation information which is independent of motion data derived from signals received by the WAN transceiver 204, the LAN transceiver 206 and the SPS receiver 208.

By way of example, the motion sensor 212 may utilize an accelerometer (e.g., a MEMS device), a gyroscope, a geomagnetic sensor (e.g., a compass), an altimeter (e.g., a barometric pressure altimeter), and/or any other type of movement detection sensor. Moreover, the motion sensor 212 may include a plurality of different types of devices and combine their outputs in order to provide motion information. For example, the motion sensor 212 may use a combination of a multi-axis accelerometer and orientation sensors to provide the ability to compute positions in 2-D and/or 3-D coordinate systems.

The processor 210 may be connected to the WAN transceiver 204, LAN transceiver 206, the SPS receiver 208 and the motion sensor 212. The processor 210 may include one or more microprocessors, microcontrollers, and/or digital signal processors that provide processing functions, as well as other calculation and control functionality. The processor 210 may also include memory 214 for storing data and software instructions for executing programmed functionality within the mobile station 200. The memory 214 may be on-board the processor 210 (e.g., within the same IC package), and/or the memory may be external memory to the processor and functionally coupled over a data bus. The functional details associated with aspects of the disclosure will be discussed in more detail below.

A number of software modules and data tables may reside in memory 214 and be utilized by the processor 210 in order to manage both communications and positioning determination functionality. As illustrated in FIG. 2, memory 214 may include and/or otherwise receive a wireless-based positioning module 216, an application module 218, and a positioning module 228. One should appreciate that the organization of the memory contents as shown in FIG. 2 is merely exemplary, and as such the functionality of the modules and/or data structures may be combined, separated, and/or be structured in different ways depending upon the implementation of the mobile station 200.

The application module 218 may be a process running on the processor 210 of the mobile device 200, which requests position information from the wireless-based positioning module 216. Applications typically run within an upper layer of the software architectures, and may include Indoor Navigation, Buddy Locator, Shopping and Coupons, Asset Tracking, and location Aware Service Discovery. The wireless-based positioning module 216 may derive the position of the mobile device 200 using information derived from time information measured from signals exchanged with a plurality of WAPs. In order to accurately determine position using time-based techniques, reasonable estimates of time delays, introduced by the processing time of each WAP, may be used to calibrate/adjust the time measurements obtained from the signals. As used herein, these time delays are referred to as “processing delays.”

Calibration to further refine the processing delays of the WAPs may be performed using information obtained by the motion sensor 212. In one embodiment, the motion sensor 212 may directly provide position and/or orientation data to the processor 210, which may be stored in memory 214 in the position/motion data module 226. In other embodiments, the motion sensor 212 may provide data which should be further processed by processor 210 to derive information to perform the calibration. For example, the motion sensor 212 may provide acceleration and/or orientation data (single or multi-axis) which can be processed using positioning module 228 to derive position data for adjusting the processing delays in the wireless-based positioning module 216.

After calibration, the position may then be output to the application module 218 in response to its aforementioned request. In addition, the wireless-based positioning module 216 may utilize a parameter database 224 for exchanging operational parameters. Such parameters may include the determined processing delays for each WAP, the WAPs positions in a common coordinate frame, various parameters associated with the network, initial processing delay estimates, etc.

In other embodiments, the additional information may optionally include auxiliary position and/or motion data which may be determined from other sources besides the motion sensor 212, such as, for example, from SPS measurements. The auxiliary position data may be intermittent and/or noisy, but may be useful as another source of independent information for estimating the processing delays of the WAPs depending upon the environment in which the mobile station 200 is operating.

For example, in some embodiments, data derived from the SPS receiver 208 may supplement the position data supplied by the motion sensor 212 (either directly from the position/motion data module 226 or derived by the positioning module 228). In other embodiments, the position data may be combined with data determined through additional networks using non-RTT techniques (e.g., AFLT within a CDMA network). In certain implementations, the motion sensor 212 and/or the SPS receiver 208 may provide all or part of the auxiliary position/motion data 226 without further processing by the processor 210. In some embodiments, the auxiliary position/motion data 226 may be directly provided by the motion sensor 212 and/or the SPS receiver 208 to the processor 210.

While the modules shown in FIG. 2 are illustrated in the example as being contained in the memory 214, it is recognized that in certain implementations such procedures may be provided for or otherwise operatively arranged using other or additional mechanisms. For example, all or part of the wireless-based positioning module 216 and/or the application module 218 may be provided in firmware. Additionally, while in this example the wireless-based positioning module 216 and the application module 218 are illustrated as being separate features, it is recognized, for example, that such procedures may be combined together as one procedure or perhaps with other procedures, or otherwise further divided into a plurality of sub-procedures.

The processor 210 may include any form of logic suitable for performing at least the techniques provided herein. For example, the processor 210 may be operatively configurable based on instructions in the memory 214 to selectively initiate one or more routines that exploit motion data for use in other portions of the mobile device.

The mobile station 200 may include a user interface 250 which provides any suitable interface systems, such as a microphone/speaker 252, keypad 254, and display 256 that allows user interaction with the mobile station 200. The microphone/speaker 252 provides for voice communication services using the WAN transceiver 204 and/or the LAN transceiver 206. The keypad 254 comprises any suitable buttons for user input. The display 256 comprises any suitable display, such as, for example, a backlit LCD display, and may further include a touch screen display for additional user input modes.

As used herein, the mobile station 108 and/or mobile station 200 may be any portable or movable device or machine that is configurable to acquire wireless signals transmitted from, and transmit wireless signals to, one or more wireless communication devices or networks. As shown in FIG. 1 and FIG. 2, the mobile station 108 and/or mobile station 200 is representative of such a portable wireless device. Thus, by way of example but not limitation, the mobile station 108 may include a radio device, a cellular telephone device, a computing device, a personal communication system (PCS) device, or other like movable wireless communication equipped device, appliance, or machine. The term “mobile station” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. Also, “mobile station” is intended to include all devices, including wireless devices, computers, laptops, etc. which are capable of communication with a server, such as via the Internet, WLAN, or other network, and regardless of whether satellite signal reception, assistance data reception, and/or position-related processing occurs at the device, at a server, or at another device associated with the network. Any operable combination of the above is also considered a “mobile station.”

As used herein, the term “wireless device” may refer to any type of wireless communication device which may transfer information over a network and also have position determination and/or navigation functionality. The wireless device may be any cellular mobile terminal, personal communication system (PCS) device, personal navigation device, laptop, personal digital assistant, or any other suitable mobile device capable of receiving and processing network and/or SPS signals.

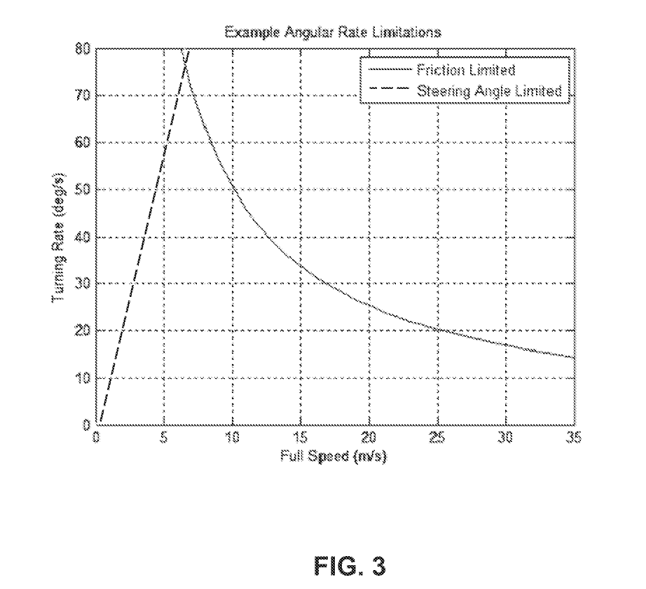

FIG. 3 shows a graph of exemplary angular rate limitations. As shown in the graph, at low speeds, the maximum turning rate of the vehicle limits the turning rate. The vehicle may also face another limitation based on its contact with its travel medium (e.g., a road, grass, water, air). At higher speeds, the limitation of the force that can be exerted by the vehicle's contact friction (e.g., wheels, treads, hull, wings, etc.) further reduces the maximum turning rate. In some embodiments, it can be assumed that any data falling above either limitation is implicitly biased. For example, if sensors provide that a car is traveling at 5 m/s and the turning rate is 70 deg/s, there is a bias according to the limitations provided. According to the values provided the car cannot have such a high turning rate at that speed.

As shown, the maximum turning rate is limited by a maximum steering angle at low speeds (e.g., parking a car). FIG. 3 also shows that the maximum turning rate is limited by force from the vehicle's contact friction with a travel medium at higher speeds. The maximum turning rate can also be limited at higher speeds by driving patterns. When the speed of the vehicle is zero, the maximum turning rate is assumed to be zero. However, the limitations can be pessimistic estimates for a safe approach to determine gyroscope bias.

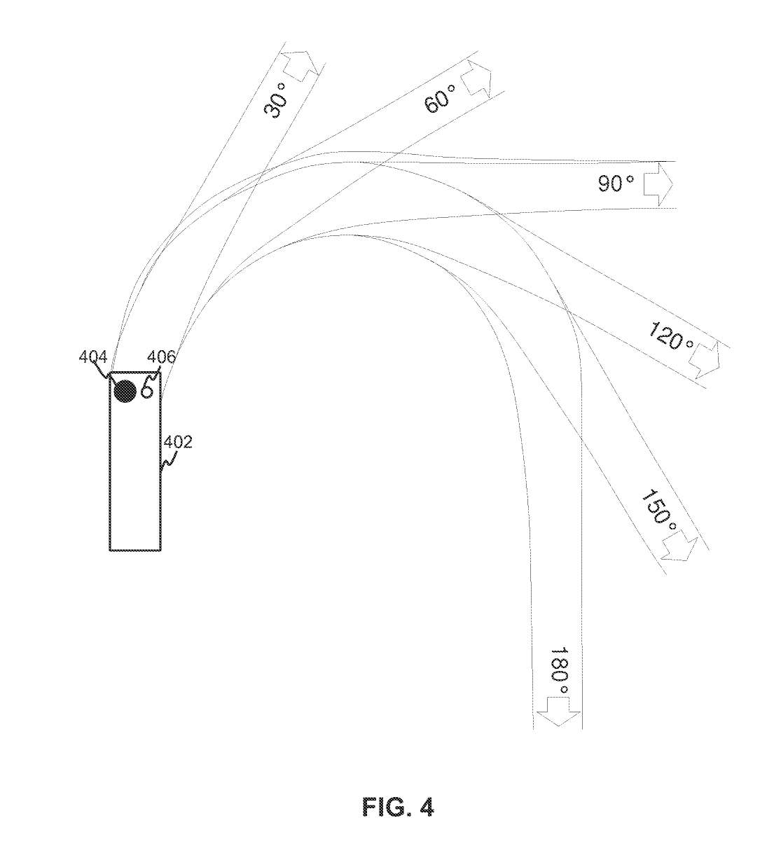

FIG. 4 illustrates an exemplary vehicle 402 with paths for different turning degrees. In the vehicle 402, there can be two different sensors. A first sensor, such as a vehicle-based sensor 404, can be a sensor that is built into the vehicle 402 and specific to that vehicle 402. A second sensor, such as an operator-based sensor 406 (e.g., a mobile device), can be specific to an operator of the vehicle. In some embodiments, the operator-based sensor 406 is the first sensor, and the vehicle-based sensor 404 is the second sensor.

The sensors 404; 406 can provide further data to determine gyroscope bias, such as vehicle information specific to the vehicle. For example, in some instances, different vehicles 402 have different turning rate abilities. A tanker truck does not have the same turning radius as a motorcycle. Nor does a sports car have the same turning radius as an airplane. This data may be collected, for example, from the vehicle's computers. The make and model of the vehicle 402 may be input as a string to provide specific limitations for that type of vehicle 402. The make and model of the vehicle 402 may also be input through the operator. The operator can provide this to the vehicle-based sensor 404 if not already present. The operator can also provide this to the operator-based sensor 406. The information can be gathered in a variety of ways, including table-lookup, VIN lookup, or a photo recognition lookup when an operator takes a picture of the vehicle 402 to be analyzed. The vehicle 402 may also provide information through a WLAN with the operator-based sensor 406.

Both sensors 404; 406 can collect further data, including data that is specific to characteristics of the operator of the vehicle 402. For example, the operator of the vehicle 402 drives to work daily. The driving characteristics of the operator can be used to form a profile. The data can be specific to the operator based on ownership of the operator-based sensor 406. Alternatively, the vehicle-based sensor 404 can take an average of the characteristics of its operation over time. In some embodiments, more than one individual can operate the vehicle 402 on a regular basis. In some embodiments, the vehicle-based sensor 404 can differentiate between operators using the seat position of the operator seat. For example, if one operator sits a foot closer than the other operator, the vehicle-based sensor 404 can designate the closer-seated data with one operator and the other data with the second operator.

In some embodiments, the data can show that the operator is most comfortable at high turning rates when operating the vehicle 402 at low speeds. This data can supplement the data provided that the vehicle 402 has a higher turning rate at low speeds. For example, if a vehicle 402 is capable of a turning rate of 35 deg/s at 15 m/s, but the characteristic history of the operator shows no instance of the turning rate above 20 deg/s at 15 m/s, this information can be useful to gyroscope bias determination.

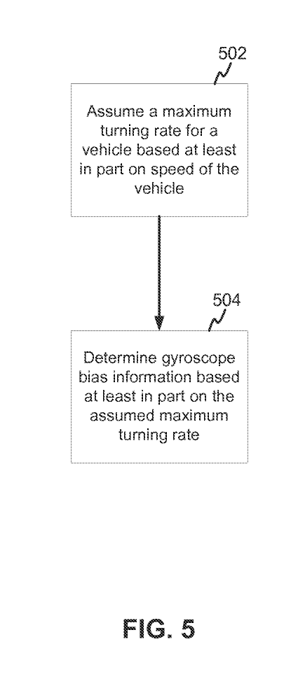

It will be appreciated that embodiments include various methods for performing the processes, functions, and/or algorithms disclosed herein. For example, as illustrated in FIG. 5, an embodiment can include a method of calculating gyroscope bias in a vehicle, comprising: assuming a maximum turning rate for a vehicle (e.g., 50 deg/s at 10 m/s as shown in FIG. 3) based at least in part on speed of the vehicle (e.g., obtaining the speed of the vehicle using odometry data or GNSS)—Block 502; and determining gyroscope bias information based at least in part on the assumed maximum turning rate (e.g., bias is present if the vehicle's turning rate is 50 deg/s at 15 m/s)—Block 504.

In some embodiments, the method can cancel out gyroscope bias information in a dead reckoning calculation. Similarly, the method can calibrate the sensor with the gyroscope bias information. For example, over time, gyroscope bias can increase; a power cycle may affect gyroscope bias; and the gyroscope bias can be temperature-dependent. Calibration can be implemented when the vehicle speed is zero. The calibration can also occur at various times during vehicle operation.

In some embodiments, the gyroscope bias information can be provided to a second sensor collecting data related to the vehicle. For example, in FIG. 4, the vehicle-based sensor 404 can provide gyroscope bias information to the operator-based sensor 406.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an electronic object. In the alternative, the processor and the storage medium may reside as discrete components in a user terminal

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for calculating gyroscope bias in a vehicle, the method comprising:
assuming a maximum turning rate for a vehicle based at least in part on speed of the vehicle; and
determining gyroscope bias information based at least in part on the assumed maximum turning rate.

2. The method of claim 1, wherein the maximum turning rate is limited by a maximum steering angle.

3. The method of claim 1, wherein the maximum turning rate is limited by force from the vehicle's contact friction with a travel medium.

4. The method of claim 1, wherein the maximum turning rate is limited by driving patterns.

5. The method of claim 1, wherein the maximum turning rate is assumed to be zero.

6. The method of claim 1, further comprising incorporating at least one of: vehicle information specific to the vehicle; and characteristics specific to an operator of the vehicle.

7. The method of claim 1, further comprising canceling out the gyroscope bias information in dead reckoning calculations.

8. The method of claim 1, further comprising calibrating a first sensor with the gyroscope bias information.

9. The method of claim 1, further comprising providing gyroscope bias information to a second sensor, wherein the second sensor is collecting data related to the vehicle.

10. An apparatus for calculating gyroscope bias in a vehicle, the apparatus comprising:
a turning rate circuit configured to assume a maximum turning rate for a vehicle based at least in part on speed of the vehicle; and
a gyroscope bias circuit configured to determine gyroscope bias information based at least in part on the assumed maximum turning rate.

11. The apparatus of claim 10, wherein the maximum turning rate is limited by a maximum steering angle.

12. The apparatus of claim 10, wherein at least one of the following is incorporated: vehicle information specific to the vehicle; and characteristics specific to an operator of the vehicle.

13. The apparatus of claim 10, wherein the gyroscope bias information is canceled out in dead reckoning calculations.

14. The apparatus of claim 10, wherein a first sensor is calibrated with the gyroscope bias information.

15. The apparatus of claim 10, further comprising a second sensor, wherein the second sensor is collecting data related to the vehicle.

16. A non-transitory computer-readable storage medium comprising code, which, when executed by a processor, causes the processor to perform operations for calculating gyroscope bias in a vehicle, the non-transitory computer-readable storage medium comprising:
code for assuming a maximum turning rate for a vehicle based at least in part on speed of the vehicle; and
code for determining gyroscope bias information based at least in part on the assumed maximum turning rate.

17. The non-transitory computer-readable storage medium of claim 16, further comprising incorporating at least one of: vehicle information specific to the vehicle; and characteristics specific to an operator of the vehicle.

18. The non-transitory computer-readable storage medium of claim 16, further comprising canceling out the gyroscope bias information in dead reckoning calculations.

19. The non-transitory computer-readable storage medium of claim 16, further comprising calibrating a first sensor with the gyroscope bias information.

20. The non-transitory computer-readable storage medium of claim 16, further comprising providing gyroscope bias information to a second sensor, wherein the second sensor is collecting data related to the vehicle.
